(19) United States
(12) Patent Application Publication
(10) Pub. No.: US 2025/0374021 A1
(43) Pub. Date: Dec. 4, 2025

(54) Methods and Systems to Provide Emergency Telecommunications Services to Emergency Personnel Using Artificial Intelligence Based Authentication

(71) Applicant: T-Mobile Innovations LLC, Overland Park, KS (US)

(72) Inventors: Mark Bonn, Granite Bay, CA (US); Kenneth George, Fulshear, TX (US); Muhammad Nauhman Bashir Gora, Irvine, CA (US); Dominick Mangiardi, Fremont, CA (US)

(21) Appl. No.: 18/732,333

(22) Filed: Jun. 3, 2024

(51) Int. Cl. H04W 4/90; G10L 17/24; H04M 11/04

(52) U.S. Cl. CPC H04W 4/90; G10L 17/24; H04M 11/045; H04M 2201/405

(57) ABSTRACT

A method comprising obtaining, using an artificial intelligence model, a trust parameter and a confidence score based on the device identifier of a user device and an access history of a user, wherein the trust parameter comprises a predicted value indicating a level of trust associated with the user device, and wherein the confidence score indicates a confidence level of the trust parameter, an authentication parameter indicating a permitted dynamic authentication for the user device based on an authentication rule, wherein the authentication rule comprises one or more conditions based on a comparison of at least one of the trust parameter or confidence score with a preset threshold, determining an authentication parameter indicating a permitted dynamic authentication for the user device based on an authentication rule, and transmitting an authentication prompt to the user device to provide the abbreviated verification credential to authenticate with the emergency telecommunications service system.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Emergency telecommunications services, such as the Government Emergency Telecommunications Service (GETS), are priority telecommunication services provided by the government to ensure essential national security and emergency personnel have expedited access to communication networks during emergency situations. For example, a GETS system providing GETS operates using existing telecommunication infrastructure and grants authorized users priority status by authenticating the emergency personnel who have valid accounts registered with the GETS system. This prioritized access ensures that critical communications from the emergency personnel are given precedence over non-priority communications and are not hindered by network congestion during emergency situations. In this way, the authorized emergency personnel can swiftly make and receive calls during emergency situations, enabling efficient and vital communication in times of heightened demand. Said another way, the service enhances emergency response capabilities by prioritizing the connectivity of those directly involved in emergency management and national security efforts.

### SUMMARY

In an embodiment, a method implemented in a communication network including an access network to provide emergency telecommunications services using artificial intelligence-based authentication is disclosed. The method comprises maintaining, by an application executed at an emergency telecommunications service system, an access history of a user registered with the emergency telecommunications service system, wherein the access history includes one or more device identifiers of user devices operated by the user when previously accessing the emergency telecommunications service system and a personal identification number provided by the user devices when previously requesting access to the emergency telecommunications service system. The method further comprises receiving, by the application, a call from a user device operated by the user, in which the call indicates a device identifier of the user device, obtaining, by the application, using an artificial intelligence model, a trust parameter and a confidence score based on the device identifier of the user device and the access history of the user, in which the trust parameter comprises a predicted value indicating a level of trust associated with the user device, and the confidence score indicates a confidence level of the trust parameter, and determining, by the application, an authentication parameter indicating a permitted dynamic authentication for the user device based on an authentication rule, in which the authentication rule comprises one or more conditions based on a comparison of at least one of the trust parameter or confidence score with a preset threshold. When the authentication parameter indicates that the user device is permitted to automatically authenticate with the emergency telecommunications service system, the method further comprises transmitting, by the application, a destination prompt to the user device indicating a predicted destination number to connect to using the emergency telecommunications service system.

In another embodiment, a method implemented in a communication network including an access network to provide emergency telecommunications services using artificial intelligence-based authentication is disclosed. The method comprises receiving, by an application executed at an emergency telecommunications service system, a call from a user device operated by a user, in which the call indicates a device identifier of the user device, obtaining, by the application, using an artificial intelligence model, a trust parameter and a confidence score based on the device identifier of the user device and an access history of the user, in which the trust parameter comprises a predicted value indicating a level of trust associated with the user device, and the confidence score indicates a confidence level of the trust parameter, and determining, by the application, an authentication parameter indicating a permitted dynamic authentication for the user device based on an authentication rule, in which the authentication rule comprises one or more conditions based on a comparison of at least one of the trust parameter or confidence score with a preset threshold. When the authentication parameter indicates that the user device is permitted to automatically authenticate with the emergency telecommunications service system, the method further comprises transmitting, by the application, a destination prompt to the user device requesting the user device to provide a destination number to connect to using the emergency telecommunications service system.

In yet another embodiment, an emergency telecommunications service system is disclosed. The emergency telecommunications service system comprises a non-transitory memory, a processor coupled to the non-transitory memory, and an application stored at the non-transitory memory. The application, when executed by the processor, causes the processor to be configured to receive a call from a user device operated by a user, in which the call indicates a device identifier of the user device, obtain, using an artificial intelligence model, a trust parameter and a confidence score based on the device identifier of the user device and an access history of the user, in which the trust parameter comprises a predicted value indicating a level of trust associated with the user device, and the confidence score indicates a confidence level of the trust parameter, determine an authentication parameter indicating a permitted dynamic authentication for the user device based on an authentication rule, in which the authentication rule comprises one or more conditions based on a comparison of at least one of the trust parameter or confidence score with a preset threshold, and when the authentication parameter indicates that the user device is permitted to authenticate with the emergency telecommunications service system using an abbreviated verification credential, transmit an authentication prompt to the user device to provide the abbreviated verification credential to authenticate with the emergency telecommunications service system, and when the authentication parameter indicates that the user device is permitted to automatically authenticate with the emergency telecommunications service system, transmit a destination prompt to the user device requesting the user device to provide a destination number to connect to using the emergency telecommunications services.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication system according to various embodiments of the disclosure.

FIG. 2 is a block diagram illustrating an embodiment for performing authentication using an artificial intelligence (AI) model in the communication system of FIG. 1 according to various embodiments of the disclosure.

FIGS. 3A, 3B, and 3C are block diagrams illustrating an embodiment for performing authentication using an AI model in the communication system of FIG. 1 according to various embodiments of the disclosure.

FIG. 4 is a block diagram illustrating an embodiment for performing authentication using an AI model in the communication system of FIG. 1 to obtain an authentication parameter according to various embodiments of the disclosure.

FIGS. 5A and 5B are message sequence diagrams illustrating methods for providing emergency telecommunications services to users using AI-based authentication according to various embodiments of the disclosure.

FIG. 6 is a flowchart of a first method of providing emergency telecommunications services using AI-based authentication according to various embodiments of the disclosure.

FIG. 7 is a flowchart of a second method of providing emergency telecommunications services using AI-based authentication according to various embodiments of the disclosure.

FIG. 8 is a block diagram of a computer system implemented within the communication system of FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As mentioned above, Government Emergency Telecommunications Service (GETS) is a priority telecommunication service that ensures emergency/first responders, authorized national security, emergency personnel, and the like (sometimes referred to herein as “user”) have prioritized access to communication networks during emergency situations. For example, the emergency personnel may first submit an application to a GETS system implementing GETS through the appropriate channels (e.g., by contacting a GETS program administrator or a designated authority responsible for managing GETS access). In the application, the user may submit eligibility credentials and/or other types of evidence verifying that the emergency personnel is indeed an emergency/first responder, national security personnel, government official, infrastructure, healthcare professional, or other emergency personnel. The GETS system (or the GETS program administrator or designated authority) may verify the submitted eligibility credentials, and when verified, issue verification credentials to the emergency personnel. The verification credentials may be issued in the form of a physical or digital card. The verification credentials may be, for example, a personal identification number (PIN) (e.g., 12-digit numerical PIN, or any other number of digits), an alphanumeric PIN, a unique identifier, or any other form of a verification credential. For example, the PIN (or other verification credential) may serve as an authentication key for accessing priority telecommunication services during emergencies.

During an emergency, the user may use a user device (e.g., mobile phone, landline phone, etc.) to initiate a call with a designated GETS line (e.g., an access number or phone number associated with a telecommunications service provider) to the GETS system for authentication. After initiating the call, the user may listen (e.g., via a speaker of the device) for an indication (e.g., dial tone, beep, etc.) signaling to the user to enter the PIN (or other verification credential). The user may then manually enter each digit of the PIN via the keypad of the user device. Alternatively, the user may speak each digit of the PIN into the microphone of the user device (e.g., say “9”-“7”-“2”-etc. into the microphone).

When the user enters the PIN into the keypad of the user device, the PIN may be forwarded through an access network associated with the telecommunications service provider to a GETS application in the GETS system. When the user speaks the PIN into the microphone of the user device, a recording of the user speaking the PIN may be forwarded through the access network to the GETS application, and the GETS application may perform voice-to-text conversion (e.g., speech recognition) on the recording to obtain the PIN provided by the user. The GETS application then verifies the received PIN against stored credentials (e.g., the stored PIN) associated with active user accounts. When the PIN is valid (matches the stored credentials), the user is granted access to GETS. The GETS application may then prompt the user to provide a destination (e.g., destination phone number) to communicate with using GETS, and the user may input the destination into the user device (e.g., again via manual entry of the destination phone number using the keypad or speaking the destination phone number into the microphone). The GETS application may then connect the user device to the destination if the connection is permitted. As mentioned above, the connected call may be processed by the GETS system with priority, ensuring an expedited and secure connection that may be exempt from overload control (i.e., prevented from being disconnected during, for example, times of high network congestion).

In some cases, the user may authenticate with the GETS system using voice verification (e.g., in which the user speaks a voice passphrase matching a voiceprint stored at a voice verification system into a microphone of the user device). The GETS system receives a voice verification key from the voice verification system when the voice passphrase matches the voiceprint. When the voice verification key is included in a user account having a PIN, the user may be considered authenticated with the GETS system. Methods and systems for voice verification with the GETS system is further described in U.S. patent application Ser. No. 18/677,876 (hereinafter referred to as the “876 Application”), which is hereby incorporated by reference in its entirety.

Regardless of whether the PIN or voice verification is used for authentication, the initial login and authentication process with the GETS system is cumbersome and complex. For the user to receive access to the privileges of GETS (or any other type of emergency telecommunications service), the user may have to remember a 12-digit PIN/have access to the card having the 12-digit PIN during an emergency situation and may have to manually enter or speak each digit of the PIN into the user device. Otherwise, the user may have to memorize a voice passphrase and speak the voice passphrase into the microphone of the user device. Moreover, the manual entry or speaking of the PIN/voice passphrase is often performed during a high-stress emergency situation. For example, the user may have to repeatedly enter the PIN into the keypad of the user device during a high-stress emergency situation until the user is concentrated enough to correctly enter the PIN. If the user is a type of emergency personnel that has to make dozens of rapid calls during an emergency situation (e.g., an emergency medical technician), this cumbersome process of manually entering the PIN becomes especially problematic—it can result in delayed calls, dropped calls, inability to access GETS, etc.

Therefore, the initial steps for GETS authentication is technically problematic for numerous reasons. First, the manual entry or speaking of the PIN/voice passphrase significantly increases call setup time and call complexity for emergency response calls, since providing this information is a time-intensive process. For example, the user may have to re-enter the PIN multiple times until the user can accurately enter the PIN (since the user may not be able to concentrate to manually enter the PIN accurately under stress in the emergency situation). In addition, the card including the PIN may be susceptible to loss and theft, and the PIN may be vulnerable to hacking, fraud, and other misuse. Lastly, manual entry of a 12-digit PIN may be susceptible to human error, which may result in the user losing prioritized access to the network during emergencies. Therefore, GETS authentication may be inefficient from a network resource and processing resource perspective due to the increased call setup time and call complexities involved in PIN authentication. Moreover, GETS authentication may be prone to error, which may again result in the loss of prioritized communications for those directly involved in emergency management and national security efforts.

The present disclosure addresses the foregoing technical problems by providing a technical solution in the technical field of authentication systems, and in particular, emergency telecommunications service systems (e.g., GETS systems). The embodiments disclosed herein may dynamically determine whether to automatically authenticate certain user devices with the GETS system or permit certain user devices to provide abbreviated verification credentials to authenticate with the GETS system. In an embodiment, the GETS system may automatically authenticate certain user devices with the emergency telecommunications service (e.g., GETS) system (also referred to herein as the “emergency system”). That is, authentication may be performed on the user device without the need for the user to manually enter the PIN, speak the voice passphrase, or provide any other verification credential. In an embodiment, the emergency system may also permit certain user devices to provide abbreviated verification credentials (e.g., a subset of the 12-digit PIN, a shorter voice passphrase, etc.) instead of the full 12-digit PIN or the full voice passphrase matching the voiceprint stored at the voice verification system. A determination of whether a user device is automatically authenticated or is permitted to use abbreviated verification credentials may be based on a trust parameter (e.g., indicating a level of trust) of the user device. The trust parameter may be based on historical data describing a history of the user device successfully authenticating and receiving access to the emergency system, through different access networks associated with different telecommunications service providers. In some embodiments, an artificial intelligence (AI) model may be used to determine or predict the trust parameter for a user device with a confidence score indicating a confidence of the predicted trust parameter. The trust parameter and confidence score may be used to determine whether a user device may be automatically authenticated or may be permitted to use abbreviated verification credentials. In this way, the dynamic authentication methods disclosed herein significantly reduce call setup time and call complexity for call completion during emergency situations, and better secure the PIN against hacking and misuse.

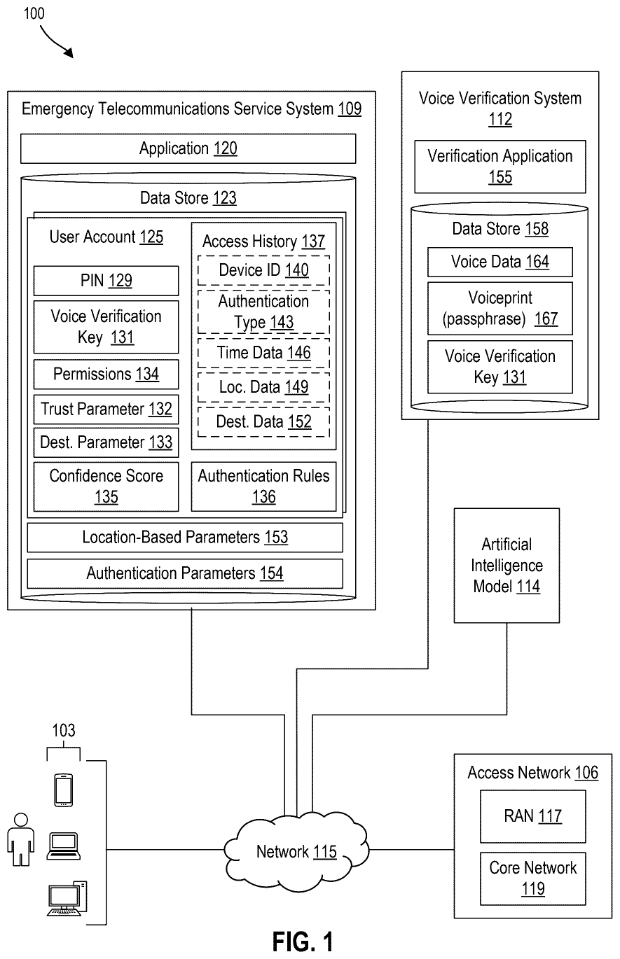

The embodiments of AI-based authentication disclosed herein may be implemented by an emergency system (e.g., a GETS system), a voice verification system, an AI model, an access network owned and operated by a telecommunications service provider, and one or more user devices operated by emergency personnel users. The emergency system, voice verification system, and access network may all be part of a communication network, as will be further described below in FIG. 1.

In an embodiment, the emergency system may include an application that may communicate with the user devices, the voice verification system, and the AI model to perform AI-based authentication of users prior to providing the user devices access to the emergency telecommunications services via the access network. The emergency system may include one or more data stores storing user accounts of the different users that have registered with the system. The user accounts may include, for example, the PIN assigned to the user, permissions associated with the user, a voice verification key when the user has enrolled in voice verification, and an access history describing a history of the user authenticating with and accessing the emergency system. For example, the access history may include device identifiers of user devices operated by the user that previously authenticated with and/or accessed the emergency system. The device identifiers may be a number or identifier identifying a user device (e.g., an automatic number identification (ANI), a mobile station international subscriber directory number (MSISDN), phone number, etc.). The access history may also include the authentication types performed by the user devices to authenticate with the emergency system (e.g., whether the user device authenticated by manually entering/speaking the PIN, whether the user device authenticated using voice verification, etc.). The access history may also include time and location data associated with each event occurring between the user device and emergency system and each event occurring during the authentication process (e.g., the initial call to the emergency system, the authentication success/failure, etc.). The access history may also include destination data describing each of the destination numbers requested by the user and successfully/unsuccessfully connected to the user device operated by the user. In this way, the access history may include historical data associated with the user.

When a user operates a user device and calls the emergency system (e.g., dials an access line associated with an access network to access the emergency system), the application at the emergency system may obtain a device identifier of the user device from the call. The application may use the device identifier to determine whether an access history included in a user account stored at the emergency system indicates that the user previously accessed the emergency system using the user device. When a user account does not indicate the device identifier, the application may prompt the user device to provide full verification credentials (e.g., the full 12-digit PIN or full voice passphrase matching the voiceprint). When a user account indeed indicates the device identifier, the application may determine a trust parameter and confidence score based on the access history included in the user account using the AI model. The trust parameter may be a value (e.g., 0-1) of a predicted trust level of the user device, which may be based on various factors, such as, for example, a history of the user device successfully authenticating with the emergency system using valid verification credentials (e.g., the full PIN). The confidence score may be a value (e.g., 0-1) representing a confidence or likelihood that the predicted trust parameter is accurate. In some cases, the greater the number of data points indicating history of the user device successfully/unsuccessfully authenticating with the emergency system, the higher the confidence score of the predicted trust parameter.

For example, suppose the access history of the user device indicates that user device (operated by the user) has successfully authenticated with the emergency system 109 times by the user providing the 12-digit PIN 100 times into the keypad of the user device. In this case, the application may use the AI model to obtain (e.g., predict or determine) a trust parameter associated with the user device, in which the trust parameter includes a value (e.g., 1) indicating a high-level of trust in the user device. The application may also use the AI model to obtain a confidence score associated with a certainty in the predicted trust parameter, in which the confidence score (e.g., 0.7-0.9) may indicate a high confidence in the prediction of the trust parameter. For example, the high confidence score may be based on a high quantity of evidence/supporting data justifying the prediction (e.g., 100 instances of successful authentication using the same 12-digit PIN by the same user device may constitute a sufficient amount of data sampling to make a strong prediction).

As another illustrative example, suppose the access history of the user device indicates that user device (operated by the user) has successfully authenticated with the emergency system ten times and unsuccessfully authenticated twice. In this case, the application may use the AI model to obtain (e.g., predict or determine) a trust parameter associated with the user device, in which the trust parameter includes a value (e.g., 0.5) indicating a medium-level of trust in the user device. The application may also use the AI model to obtain a confidence score associated with the predicted trust parameter, in which the confidence score (e.g., 0.1 to 0.3) may indicate a low confidence in the prediction of the trust parameter. The low confidence score may be based on weak evidence or lack of supporting data justifying the prediction (e.g., only 12 authentication attempts may not constitute a sufficient amount of data sampling to make a strong prediction).

Once the trust parameter and confidence score are obtained, the application may determine an authentication parameter indicating a permitted dynamic authentication for the user device (e.g., automatic authentication/abbreviated authentication) based on one or more authentication rules. The authentication rules may include one or more conditions that, when met, may indicate a permitted dynamic authentication for a user device. For example, the conditions may indicate that when the trust parameter is greater than a first preset threshold and/or when the confidence score is greater than a second preset threshold, the user device may be automatically authenticated for a predefined period of time (as indicated in the authentication rule). In this case, the user device may not have to provide any form of verification credential to receive access to the services. Instead, the application may directly prompt the user device for a destination number to connect with the user device. In an embodiment, the application may also obtain (e.g., predict or determine) a destination number for the user device using the AI model based on the destination data included in the access history associated with the user device. For example, the access history associated with the user device may indicate that the user device has requested a connection with a particular destination number 90% of the time. In this case, the application may predict that the user device is likely to request connection to this destination number, and this prediction may be associated with a high confidence score based on, for example, the quantity of data samples. The destination prompt sent to the user device may include the predicted destination number, such that the user may confirm whether or not to request a connection to the predicted destination number.

As another example, the conditions in an authentication rule may indicate that when the trust parameter is greater than a first preset threshold but less than a second preset threshold and/or when the confidence score is greater than a third preset threshold but less than the fourth preset threshold, the user device may be authenticated using an abbreviated verification credential. For example, the user device may be prompted to provide at least an abbreviated verification credential to receive access to the services. For example, the abbreviated verification credential may be a subset of the digits (e.g., the last 4 digits) of the 12-digit PIN. The application may receive the subset of digits, and determine whether the subset of digits is included in the PIN of the user account associated with the user to authenticate the user device with the emergency telecommunications service system. As another example, the abbreviated verification credential may also be a shortened voice passphrase, which may correspond to a portion of the voiceprint stored at the voice verification system in association with the user. For example, the voiceprint stored in association with the user may be a vocal recording/data including a statement and an indication of the last 4 digits of the 12-digit PIN (e.g., “It's me 0 4 3 6”). The shortened voice passphrase may be “It's me”, “0 4 3 6”, or another voice passphrase not necessarily included in the voiceprint. A verification application may still authenticate the user based on the shortened voice passphrase using the voice data of the user stored at the voice verification system identifying the distinct vocal features of the user and voice biometrics/verifications algorithms of the voice verification system. The verification application may receive the shortened voice passphrase, determine whether the shortened voice passphrase is consistent with the voiceprint/voice data of the user at least above a threshold confidence level, and then pass a voice verification key back to the application at the emergency system indicating the verification of the shortened voice passphrase. The application may validate that the voice verification key is stored in the user account associated with the user device to authenticate the user device with the emergency system.

As yet another example, the conditions may indicate that when the trust parameter is less than a first preset threshold and/or when the confidence score is less than a second preset threshold, the user device may be prompted to provide complete verification credentials. For example, the user device may be prompted to provide either the full 12-digit PIN or a voice passphrase matching the voiceprint stored at the voice verification system. In this case, the application may authenticate the user device by verifying the 12-digit PIN or the voice verification system may authenticate the user by determining whether the voice passphrase matches the voiceprint, as described in the '876 Application.

In an embodiment, when the authentication parameter indicates that the user device is not to be automatically authenticated, the application may still consider other factors to override this determination and instead automatically authenticate the user device. For example, the other factors may include location-based parameters. The location-based parameters may include at least one of a location of the user device, a cell tower to which the user device is communicatively attached, and/or the successful authentication of at least a threshold number of other devices within a threshold distance from the user device. For example, the application may determine that the cell tower to which the user device is attached is within range of an ongoing emergency crisis for which timing of communications may be deemed critical. In this case, the application may automatically authenticate the user device (e.g., not prompt the user device for any form of a verification credential) to save time and vastly increase call completion speed for the user during the emergency crisis. As another illustrative example, the application may determine that at least ten other user devices within a threshold distance of the user device has successfully authenticated with the emergency system. In this case, the application may determine that an emergency situation has occurred based on the number of proximate devices accessing the system, and permit the user device to automatically authenticate with the system. In yet another example, the application may determine that the user device is positioned in a high-urgency location (e.g., a hospital, a fire station, etc.) via various geo-location methods (e.g., global positioning system (GPS), geofencing, etc.). The application may automatically authenticate user devices positioned in the high-urgency locations to again increase call completion speed for calls made by the user devices in the high-urgency locations.

As should be appreciated, the user devices referred to herein may not necessarily be owned by the user, but the user may instead call into the access line described above to use any device available in an emergency crisis. Similarly, the user devices may call a specific access line for any telecommunications service provider to use the emergency services provided in part by the underlying infrastructure for the respective service provider. The verification credential (e.g., PIN or voiceprint) may be the same regardless of the access line/telecommunications service provider used to provide the emergency telecommunications services to the user.

In this way, the embodiments disclosed herein serve to reduce call setup time and call complexity during call completion using emergency telecommunications services. The embodiments disclosed herein also provide for increased security for these services by in some cases removing the potential for hacking or misuse of the PIN/voiceprint of the user (e.g., since the user may not need to provide this information when using trusted user devices). Therefore, in general, the embodiments disclosed herein also serve to increase system capacity by decreasing human errors and increasing call efficiency.

Turning now to FIG. 1, a communication network 100 is described. The communication network 100 includes one or more user devices 103 (sometimes referred to herein in the singular as “user device 103”), an access network 106, an emergency telecommunications service system 109 (e.g., a GETS system), a voice verification system 112, an artificial intelligence (AI) model 114, and network 115. Network 115 may be one or more private networks, one or more public networks, or a combination thereof, interconnecting the user devices 103, access network 106, emergency telecommunications service system 109, AI model 114, and voice verification system 112. While FIG. 1 illustrates the access network 106, emergency telecommunications service system 109, AI model 114, and voice verification system 112 as being separate from the network 115, it should be appreciated that in some embodiments, the access network 106, emergency telecommunications service system 109, AI model 114, and voice verification system 112 may be part of the network 115. While FIG. 1 illustrates the emergency telecommunications service system 109 as being separate from the voice verification system 112, it should be appreciated that in some embodiments, the emergency telecommunications service system 109 may include the voice verification system 112. While FIG. 1 illustrates the AI model 114 as being separate from the emergency telecommunications service system 109 and voice verification system 112, it should be appreciated that in some embodiments, the AI model 114 may be included as part of the emergency telecommunications service system 109 and/or the voice verification system 112.

The user devices 103 may be devices, such as, for example, user equipment (UE), cell phone, a mobile phone, a smart phone, a tablet computer, a landline phone, a satellite phone, a public payphone, a government communication system, a voice over internet protocol (VOIP) phone, a laptop, a personal computer, or any other type of communication device that is compatible with the public switched telephone network (PSTN). Each of the user devices 103 may be operated by an emergency personnel (also referred to herein as a “user”) that is registered with the emergency telecommunications service system 109. Each of the user devices 103 may not be necessarily owned by the user, but instead may simply be operated by the user as described herein. For example, the user device 103 may be a public payphone, or a cell phone owned by a friend of the user that the user is borrowing to make an emergency call. As described herein, the user device 103 may be any type of communication device that is capable of calling an access number associated with the access network 106.

The user devices 103 may be connected to the network 115 using a wired or wireless communication link (e.g., using a local area network or a base station, and communicating to the network 115 via a cellular or WiFi connection). For example, the user devices 103 may communicate with the network 115 according to a 5G, a long term evolution (LTE), a code division multiple access (CDMA), or a global system for mobile communications (GSM) wireless telecommunication protocol.

The access network 106 may be a telecommunications access network owned and operated by a telecommunications service provider. The access network 106 may leverage the infrastructure of PSTN and other communication networks. The access network 106 may include a radio access network (RAN) 117, a core network 119, and other network elements (e.g., routers, switches, gateways, bridges, virtual private networks (VPNs), virtual functions, etc.). The RAN 117 may facilitate wireless communication and may include various network elements, such as, for example, cell towers and base stations. The RAN 117 may allow authorized users to connect to the services using the user devices 103, providing flexibility and coverage in various locations. The core network 119 may handle the processing, routing, and management of the emergency communications, ensuring prioritized access for authorized users during emergencies.

In some cases, the RAN 117 is used by the emergency telecommunications service system 109 to provide prioritized access for registered users that have authenticated with the emergency telecommunications service system 109, using the authentication methods described herein. For example, prioritized access may ensure that communications initiated by the users are given precedence over non-priority communications and may not be hindered by network congestion. As described herein, once a user is authenticated with the emergency telecommunications service system 109, the user may request a connection (e.g., a call) to a destination phone number. If the connection is permitted, the emergency telecommunications service system 109 may complete the requested connection between the user device 103 by performing various prioritizing actions. For example, the emergency telecommunications service system 109 may complete the requested connection from the user device by dropping an on-going call of a non-emergency personnel to make a radio communication link in the RAN 117 available for the connection. As another example, the emergency telecommunications service system 109 may complete the requested connection from the user device 103 by granting prioritized access to limited radio communication links in the RAN 117 to the user device 103.

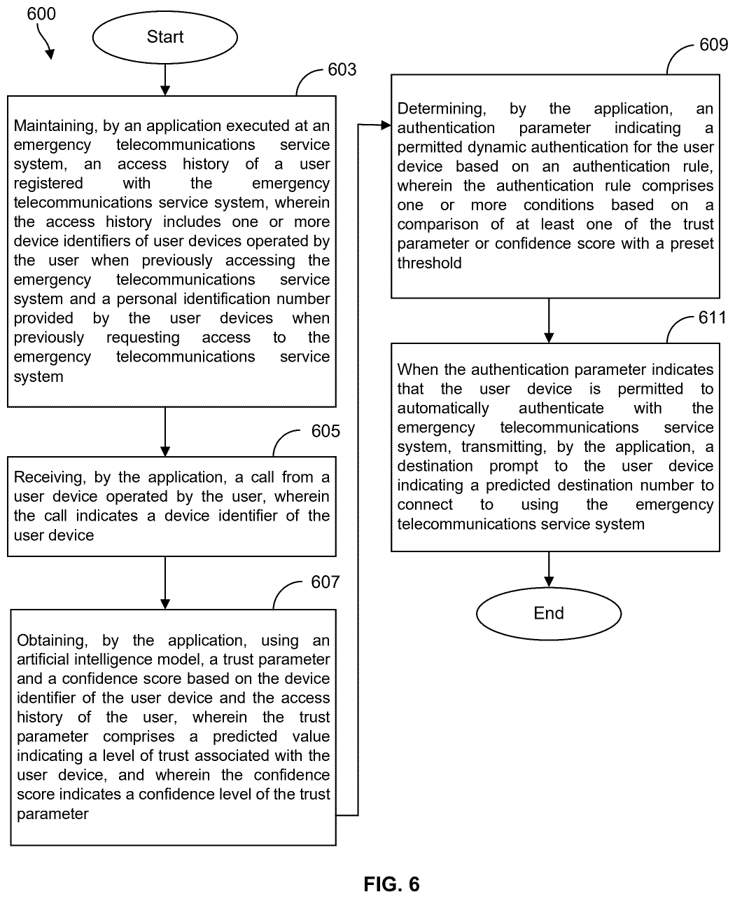

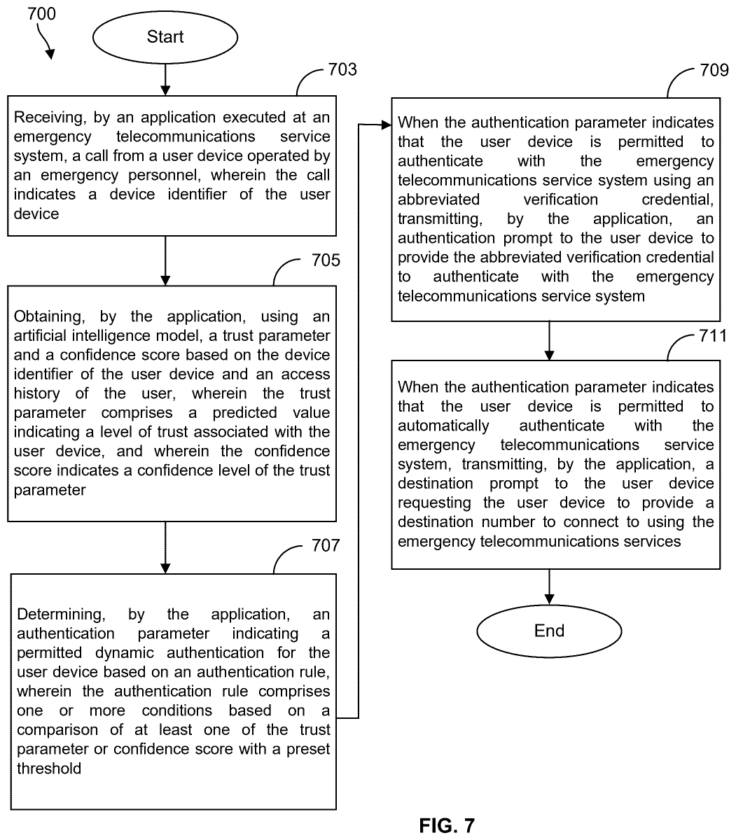

The emergency telecommunications service system 109 (also referred to herein as the “emergency system 109” or “GETS system 109”) may be a computer system, server software/hardware, or a collection of processors, memories, and/or networking resources used to perform voice verification with the user devices 103 and the voice verification system 112 and to perform dynamic authentication methods with user devices 103. The emergency system 109 may include an application 120, which may include instructions stored in a memory of the emergency system 109 that when executed by a processor of the emergency system 109, may cause the application 120 to perform various steps as disclosed herein. For example, the application 120 may perform the steps of methods 600 and 700 of FIGS. 6 and 7, respectively, as further described below.

The emergency system 109 may further include a data store 123. The data store 123 may include one or more memories located together or in a distributed manner. The data store 123 may store a user account 125 for one or more users that have completed the application and eligibility credentialing processes to receive a PIN 129 that may be used to authorize access to the emergency telecommunications services provided by the emergency system 109. The user account 125 may include the value of the PIN 129, a voice verification key 131, permissions 134 associated with the user of the PIN 129, and an access history 137 associated with the user of the PIN 129. The voice verification key 131 may be a value received from the voice verification system 112 indicating that the user has completed voice verification registration with the voice verification system 112. The permissions 134 may indicate actions (e.g., calls or types of calls) that the user may complete or may be prohibited from completing using the prioritized access provided by the emergency telecommunications services.

The access history 137 may maintain on-going data describing each event occurring between a user device 103 of the user and the emergency system 109. For example, the access history 137 may include device identifiers 140 (e.g., ANIs, MSISDNs, etc.) of the user devices 103 that have authenticated with the emergency system 109 using the PIN 129, the authentication type 143 performed by each user device 103 (e.g., PIN-based verification or voice verification), time data 146 describing the times that the user device 103 has called the emergency system 109 or that the emergency system 109 has prompted the user device 103 (e.g., for voice verification registration, for the PIN, for the destination, etc.), location data 149 describing the locations (e.g., geographical locations, serving cell site/towers, etc.) of the user devices 103 authenticating with the emergency system 109 or being prompted by the emergency system 109, destination data 152 identifying destination phone numbers that have been requested by the user devices 103 and/or for which a call has been completed. In some cases, the application 120 may collect this data upon the occurrence of each event (e.g., interaction between the user devices 103 and the emergency system 109 or task performed by the emergency system 109) and add the data to the access history 137 in the user account 125.

The user account 125 may also include one or more trust parameters 132, destination parameters 133, confidence scores 135, authentication rules 136, location-based parameters 153, and authentication parameters 154. A trust parameter 132 may refer to a predicted value indicating a level of trust associated with the user device 103. A destination parameter 133 may refer to a predicted destination number for a user device 103, which may be based on the destination data 152 in the user account 125. A confidence score 135 may refer to a value indicating a level of confidence associated with the predicted trust parameter 132 and/or the predicted destination parameter 133. The authentication rules 136 may be rules or policies including one or more conditions that are based on a comparison of the trust parameter 132 and/or the confidence score 135 with a preset threshold. The trust parameter 132 and/or the confidence score 135 associated with a user device 103 calling the emergency system 109 may be applied to one or more authentication rules 136 to obtain an authentication parameter 154. The authentication parameter 154 may indicate a permitted dynamic authentication for the user device 103 (e.g., whether to automatically authenticate the user device 103, prompt the user device 103 for an abbreviated verification credential, or prompt the user device 103 for a complete verification credential).

The voice verification system 112 may be a computer system, server software/hardware, or a collection of processors, memories, and/or networking resources used to perform voice verification with the user devices 103 and the emergency system 109. The voice verification system 112 may include a verification application 155, which may include instructions stored in a memory of the voice verification system 112 that when executed by a processor of the voice verification system 112, may cause the verification application 155 to perform various steps described in the '876 Application.

For example, when the user device 103 is registering or enrolling for voice verification, the user device 103 may transmit voice data 164 and a voiceprint 167 (passphrase) to the voice verification system 112. The voice data 164 may include multiple voice samples (e.g., recordings of predefined phrases or terms spoken by the user into a microphone of the user device 103), which may be used by the verification application 155 to extract specific features of the user's voice. For example, the voice samples may include enrollment phrases that may cover a range of speech sounds/patterns, prompted responses showcasing the user's natural speaking style and voice modulation, randomly generated passages, digit sequences that capture variations in pitch, rhythm, pronunciation, accent, etc. The voiceprint 167 may be a recording of the user speaking a particular passphrase into the microphone of the user device 103. The voiceprint 167 may not only be used to identify or verify the speaker/user based on the vocal characteristics and nuances of the user's voice, but the passphrase (e.g., content) of the voiceprint 167 may also be used to identify or verify the speaker/user. For example, the voiceprint 167 may include a recording of the user speaking 4 digits of the PIN 129, such that the voice of the user in the recording may be used to authenticate the user and the 4 digits of the PIN 129 may also be used to authenticate the user. The verification application 155 may generate a voice verification key 131 once the voice data 164 and the voiceprint 167 have been registered at the voice verification system 112.

The verification application 155 may use voice biometrics and other artificial intelligence/machine learning based algorithms (e.g., using the AI model 114) to perform voice and speech recognition based on the voice data 164 received from the user and the voiceprint 167. For example, when a user device 103 requests use of the emergency telecommunications services, the user may provide a voice passphrase via the microphone of the user device 103 (ideally matching the voiceprint 167 of the user). The voice passphrase may be passed to the voice verification system 112, and the verification application 155 may compare the voice passphrase with the stored voiceprints 167 to identify a match (e.g., determine whether the voice passphrase is consistent with the voiceprint 167 at least to a threshold confidence level) using the voice data 164.

The voice verification system 112 may also include a data store 158. The data store 158 may include one or more memories located together or in a distributed manner. The verification application 155 may store the voice data 164 and the voiceprint 167 in association with each other at the data store 158 during voice verification registration of the user. The verification application 155 may also store the voice verification key 131 of the user after completing the voice verification registration of the user.

The AI model 114 may be a computer system (e.g., including both software and hardware components) designed to make predictions or forecasts (e.g., the trust parameter 132, destination parameter 133) based on patterns or trends learned from historical data (e.g., access histories 137). The AI model 114 may be implemented using software (e.g., algorithms, logic, and code) stored across memories. The host of the AI model 114 (which may be an external server, the emergency system 109, and/or the voice verification system 112) may provide the computational resources for execution of the AI model 114. The AI model 114 may be implemented as one or more different types of models using, for example, linear regression, decision trees, support vector machines, neural networks, or ensemble methods. The AI model 114 may be a machine learning model, deep learning model, neural networking model, natural language processing (NLP) model, or any other type of AI model. It should be appreciated that any type of AI/predictive model may be used, and the underlying algorithms, computations, and machine learning libraries used by the AI model 114 should not be limited herein.

The AI model 114 may be trained using the access histories 137 of different users and other known data, such that the data points and algorithms in the AI model 114 may be used to identify patterns/trends to predict the trust parameter 132 with a confidence score 135. The AI model 114 may also be trained using the destination data 152 of the users to again identify patterns/trends to predict the destination parameter 133 with a confidence score 135. In some cases, the voice verification system 112 may also use the AI model 114, in conjunction with voice biometrics and other voice verification algorithms, when predicting whether a voice passphrase or shortened voice passphrase is consistent with the voiceprint 167 and/or the voice data 164 of a user enrolled at the voice verification system 112.

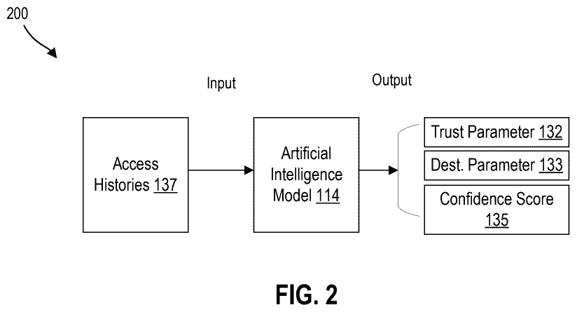

Referring now to FIG. 2, shown is a block diagram illustrating an AI-based authentication method 200 implemented by the emergency system 109 and/or the voice verification system 112 to authenticate the user device 103 according to various embodiments of the disclosure. The AI-based authentication method 200 uses the AI model 114, which as described above may be trained using various types of data to identify patterns/trends and predict the trust parameter 132 and/or the destination parameter 133 with a confidence score 135. The AI model 114 may be trained with a sufficient amount of data sampling based on known trust levels and known destination numbers in advance prior to using the AI model 114 for authentication.

Once trained, the AI model 114 may be used to predict the trust parameter 132 and the destination parameter 133. For example, when a call from a user device 103 is received by the application 120 at the emergency system 109, the application 120 may obtain the device identifier 140 from the call, and then determine whether the device identifier 140 is identified in an access history 137 of a user account 125 stored at the data store 123. When the device identifier 140 is indicated in a user account 125, the application 120 may provide the access history 137 of the user account 125 (e.g., particularly the correlations between the device identifiers 140 and the authentication types 143) as input into the AI model 114. The AI model 114 may identify trends and patterns based on the access history 137 of the user account 125. For example, the AI model 114 may identify a pattern that the user device 103 has successfully authenticated 100 times by providing the 12-digit PIN 129. The AI model 114 may then obtain (e.g., determine, predict), based on the algorithms programmed into the AI model 114, the trust parameter 132 and/or the destination parameter 133 based on the identified patterns and trends. The AI model 114 may also determine a confidence score 135 indicating a confidence level of the predicted trust parameter 132 and/or the destination parameter 133. The determination of the confidence score 135 may be based on various factors, such as, for example, the quality, quantity, and/or diversity of the pertinent data used to train the AI model 114 (“pertinent training data”), the relevance/importance of the features and/or input data, the weights of the features in the AI algorithms, etc. The artificial intelligence model 114 may then output the trust parameter 132 and/or destination parameter 133, each with a confidence score 135 to the application 120. The application 120 may store the trust parameter 132 and/or destination parameter 133 (and associated confidence scores 135) related to the user device 103 in the user account 125 associated with the user device 103.

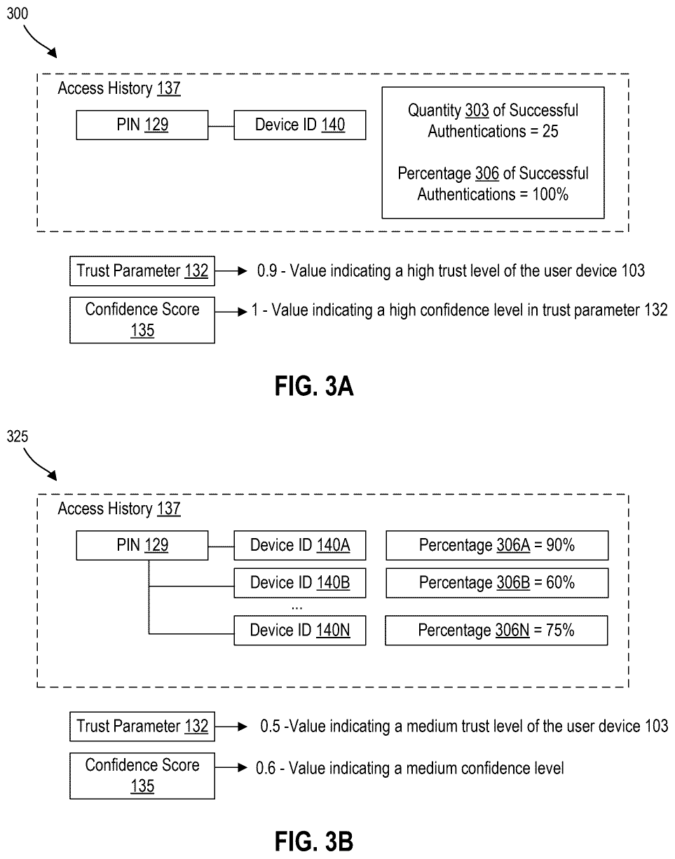

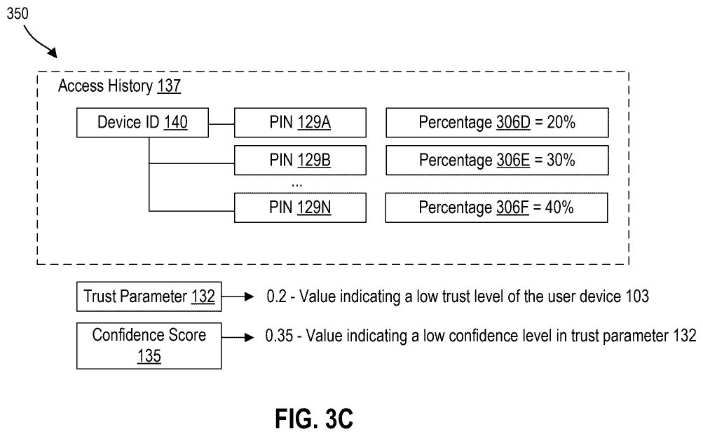

Turning now to FIGS. 3A, 3B, and 3C, shown are block diagrams illustrating use-cases of the AI-based authentication method 200 of FIG. 2 according to various embodiments of the disclosure. In particular, FIGS. 3A, 3B, and 3C illustrate examples of the trust parameters 132 and confidence scores 135 that may be obtained based on variations in the access histories 137 associated with different user devices 103.

Referring now specifically to FIG. 3A, shown is a block diagram illustrating a first use-case 300 in which a trust parameter 132 and confidence score 135 may be determined (e.g., by the application 120 using the AI model 114 as shown in FIG. 2) based on an access history 137 of a user device 103 according to various embodiments of the disclosure. As shown in FIG. 3A, an access history 137 of a user device 103 (e.g., that has called the emergency system 109 and requested access to the services) indicates that a device identifier 140 has been authenticated using the PIN 129 (e.g., indicated in the authentication type 143 of the access history 137) about 25 times within a predefined time period. The access history 137 of the user device 103 may also indicate that the user device 103 has successfully authenticated with the PIN 129 100% of the time within the predefined time period. In other words, the user device 103 identified by the device identifier 140 has a high quantity 303 of successful authentications and a high percentage 306 of successful authentications within the predefined period of time.

The application 120 may obtain, using the AI model 114, based on the data from the aforementioned access history 137, a trust parameter 132 for the user device 103 and a confidence score 135 of the trust parameter 132. In the example shown in FIG. 3A, the trust parameter 132 may be a value of 0.9 indicating a high trust level of the user device 103 (e.g., based on the high quantity 303 of successful authentications and a high percentage 306 of successful authentications within the predefined period of time). In the example, the confidence score 135 may be a value of 1 indicating a high confidence level in the likelihood that the trust parameter 132 is accurate. For example, the value corresponding to a high trust parameter 132 and a high confidence score 135 may be anywhere between 0.7 to 1.0, based on various factors, such as, for example, the quality, quantity, and diversity of the pertinent training data. However, it should be appreciated that the value corresponding to a high trust parameter 132 and a high confidence score 135 may be any numerical value.

Referring now specifically to FIG. 3B, shown is a block diagram illustrating a second use-case 325 in which a trust parameter 132 and confidence score 135 may be determined (e.g., by the application 120 using the AI model 114 as shown in FIG. 2) based on an access history 137 of multiple user devices 103 according to various embodiments of the disclosure. As shown in FIG. 3B, an access history 137 (from a single user account 125 or multiple user accounts 125) may indicate that multiple different user devices 103 (each having different device identifiers 140A-N) have authenticated with the emergency system 109 using a single PIN 129. For example, this situation may occur when a group of users offering services in response to an emergency situation have all been provided the same PIN 129 to use across separate user devices 103. Each of the different user devices 103 identified by different device identifiers 140A-N may have a different percentage 306A-N of successful authentications within a predefined time period. As shown in FIG. 3B, the user device 103 identified by device identifier 140A may have a 90% successful authentication percentage 306A within a predefined time period (e.g., 9 out of 10 authentication attempts were successful). Similarly, the user device 103 identified by device identifier 140B may have a 60% successful authentication percentage 306B within the predefined time period, and the user device 103 identified by device identifier 140N may have a 75% successful authentication percentage 306N within the predefined time period. Therefore, in this scenario, the data sampling in the access history 137 is more scattered, which may affect the trust parameter 132 associated with each of the user devices 103 identified by each of the different device identifiers 140A-N, and which may correspondingly affect the confidence scores 135 of the trust parameters 132.

In the example shown in FIG. 3B, the application 120 may obtain, using the AI model 114, based on the data from the aforementioned access history 137, a trust parameter 132 for the user device 103 and a confidence score 135 of the trust parameter 132. The trust parameter 132 may be a value of 0.5 indicating a medium trust level of the user device 103 (e.g., based on the scattered data from the access history 137). In the example, the confidence score 135 may be a value of 0.6 indicating a medium confidence level reflecting a likelihood that the trust parameter 132 may be accurate about 60% of the time. For example, the value corresponding to a medium trust parameter 132 and a medium confidence score 135 may be anywhere between 0.4 to 0.7, based on various factors, such as, for example, the quality, quantity, and diversity of the pertinent training data. However, it should be appreciated that the value corresponding to a medium trust parameter 132 and a medium confidence score 135 may be any numerical value.

Referring now specifically to FIG. 3C, shown is a block diagram illustrating a third use-case 350 in which a trust parameter 132 and confidence score 135 may be determined (e.g., by the application 120 using the AI model 114 as shown in FIG. 2) based on an access history 137 of a user device 103 according to various embodiments of the disclosure. As shown in FIG. 3C, an access history 137 (from a single user account 125 or multiple user accounts 125) may indicate that a single user device 103 identified by the device identifier 140 may have authenticated with the emergency system 109 using multiple different PINs 129A-N. For example, this situation may occur when a group of users (e.g., firemen) are operating a single user device 103 (e.g., a landline) at a service providing location (e.g., a fire station) using different PINs 129A-N allocated to each of the different users. Each user may use the single user device 103 to make different calls to the emergency system 109 using different PINs 129A-N, and only a subset of the calls to the emergency system 109 may have been successfully authenticated within a predefined time period. As shown in FIG. 3C, a first user may have attempted authentication with the emergency system 109 by providing the PIN 129A to the user device 103 identified by the device identifier 140 a first quantity 303 of times, but only a percentage 306D of the attempted authentications may have been successful (e.g., 20% as shown in FIG. 3C). Similarly, a second user may have attempted authentication with the emergency system 109 by providing the PIN 129B to the user device 103 identified by the device identifier 140 a second quantity 303 of times, but only a percentage 306E of the attempted authentications may have been successful (e.g., 30% as shown in FIG. 3C). Lastly, an Nth user may have attempted authentication with the emergency system 109 by providing the PIN 129N to the user device 103 identified by the device identifier 140 an Nth quantity 303 of times, but only a percentage 306F of the attempted authentications may have been successful (e.g., 40% as shown in FIG. 3C). Therefore, in this scenario, the data sampling in the access history 137 is again more scattered, which may affect the trust parameter 132 associated with each of the user device 103 identified by device identifier 140, and which may correspondingly affect the confidence scores 135 of the trust parameters 132.

In the example shown in FIG. 3C, the application 120 may obtain, using the AI model 114, based on the data from the aforementioned access history 137, a trust parameter 132 for the user device 103 and a confidence score 135 of the trust parameter 132. The trust parameter 132 may be a value of 0.2 indicating a low trust level of the user device 103 (e.g., based on the scattered data from the access history 137). In the example, the confidence score 135 may be a value of 0.35 indicating a low confidence level reflecting the likelihood that the trust parameter 132 may be accurate about 35% of the time. For example, the value corresponding to a low trust parameter 132 and a low confidence score 135 may be anywhere between 0 to 0.4, based on various factors, such as, for example, the quality, quantity, and diversity of the pertinent training data. However, it should be appreciated that the value corresponding to a low trust parameter 132 and a low confidence score 135 may be any numerical value.

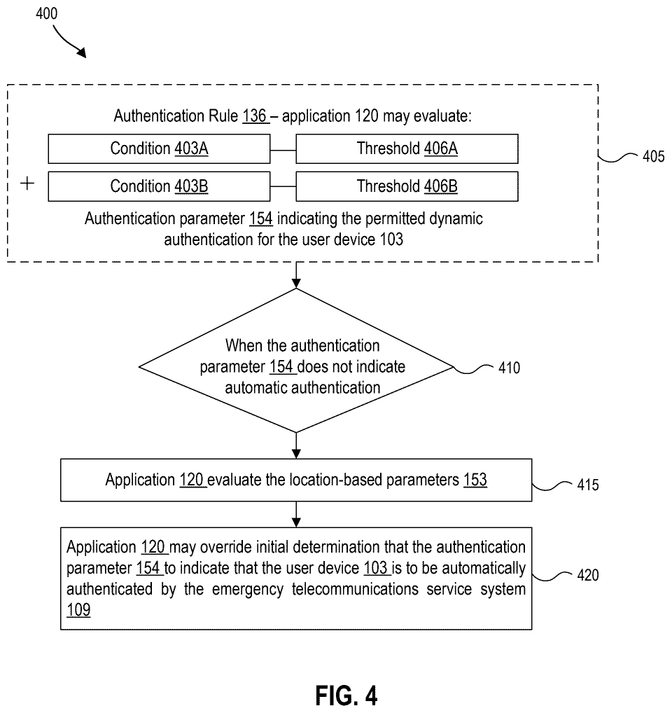

Referring now to FIG. 4, shown is a block diagram illustrating a method 400 for determining an authentication parameter 154 using the AI-based authentication method 200 of FIG. 2 according to various embodiments of the disclosure. Method 400 may begin with operation 405, in which application 120 may obtain the trust parameter 132 and the corresponding confidence score 135 as described above, and then apply the trust parameter 132 and/or the confidence score 135 to one or more authentication rules 136 to obtain an authentication parameter 154. The authentication parameter 154 may indicate a permitted dynamic authentication for the user device 103.

The authentication rules 136 may include one or more conditions 403A and/or 403B that, when met, may indicate the authentication parameter 154 (i.e., the permitted dynamic authentication) for the user device 103. The conditions 403A and/or 403B may be based on a comparison to one or more thresholds 406A and/or 406B. For example, the first condition 403A may be a comparison between the trust parameter 132 and a first threshold 406A, such that when the trust parameter 132 exceeds (or is less than) the first threshold 406A, the first condition 403A may be met. Similarly, the second condition 403B may be a comparison between the confidence score 135 and a second threshold 406B, such that when the confidence score 135 exceeds (or is less than) the second threshold 406B, the first condition 403A may be met. For example, when both of these conditions 403A and 403B are met, the authentication parameter 154 may indicate that the permitted dynamic authentication for the user device 103 is automatic authentication. In this case, the application 120 may automatically authenticate the user device 103 (e.g., without the user device 103 providing any verification credentials). Alternatively, when both of these conditions 403A and 403B have not been met, the authentication parameter 154 may indicate that the permitted dynamic authentication for the user device 103 is only full authentication (e.g., not automatic authentication or abbreviated authentication). In this case, the authentication performed by the application 120 may prompt the user device 103 to provide the full form of the verification credentials (e.g., the 12-digit PIN 129 or a voice passphrase matching the voiceprint 167) to the emergency system 109. Alternatively, when one of these conditions 403A and 403B are not met, the authentication parameter 154 may indicate that the permitted dynamic authentication for the user device 103 is full authentication or abbreviated authentication.

In some cases, the trust parameter 132 and/or the confidence score 135 may each be compared to multiple thresholds 406A and 406B in a single condition 403A or 403B. For example, the first condition 403A may be a comparison between the trust parameter 132, a first threshold 406A, and a second threshold 406A, such that when the trust parameter 132 is greater than (or less than) the first threshold 406A and less than (or greater than) the second threshold 406A, the first condition 403A may be met. Similarly, the second condition 403B may be a comparison between the confidence score 135, a first threshold 406B, and a second threshold 406B, such that when the confidence score 135 is greater than (or less than) the first threshold 406B and less than (or greater than) the second threshold 406B, the second condition 403B may be met. For example, when both of these conditions 403A and 403B are met, the authentication parameter 154 may indicate that the permitted dynamic authentication for the user device 103 is abbreviated authentication. In this case, the application 120 may prompt the user device 103 to provide abbreviated verification credentials (e.g., a subset of the PIN 129 or a voice passphrase that may be identified as consistent with the voiceprint 167 and/or the voice data 164) to the emergency system 109. Alternatively, when one of these conditions 403A and 403B are not met, the authentication parameter 154 may indicate that the permitted dynamic authentication for the user device 103 is full authentication.

In some cases, the authentication parameter 154 may indicate that automatic authentication is not a permitted dynamic authentication for the user device 103 (shown in the decision block 410 of FIG. 4). In this case, certain additional operations may be performed by the application 120. The additional operations may begin with operation 415, in which the application 120 evaluates the location-based parameters 153 to determine whether to override the initial determination of the authentication parameter 154 and instead permit automatic authentication for the user device 103. For example, the application 120 may determine, based on the location-based parameters 153, that the cell tower to which the user device 103 is attached is within range of an ongoing emergency crisis for which timing of communications may be deemed critical. In this case, the application 120 may perform operation 420 to override the initial determination of the authentication parameter 154 and to instead indicate that the user device 103 is to be automatically authenticated by the emergency system 109 for a preset period of time (e.g., a few hours). The application 120 may then automatically authenticate the user device 103 (e.g., not prompt the user device for any form of a verification credential) to save time and vastly increase call completion speed for the user during the emergency crisis.

As another illustrative example, the application 120 may determine, based on the location-based parameters 153, that at least ten other user devices 103 within a threshold distance of the user device 103 has successfully authenticated with the emergency system 109 within a predefined time period. In this case, the application 120 may determine that an emergency situation has occurred based on the number of proximate devices accessing the system. The application 120 may then perform operation 420 to override the initial determination of the authentication parameter 154 to instead indicate that the user device 103 is to be automatically authenticated by the emergency system 109 for a preset period of time.

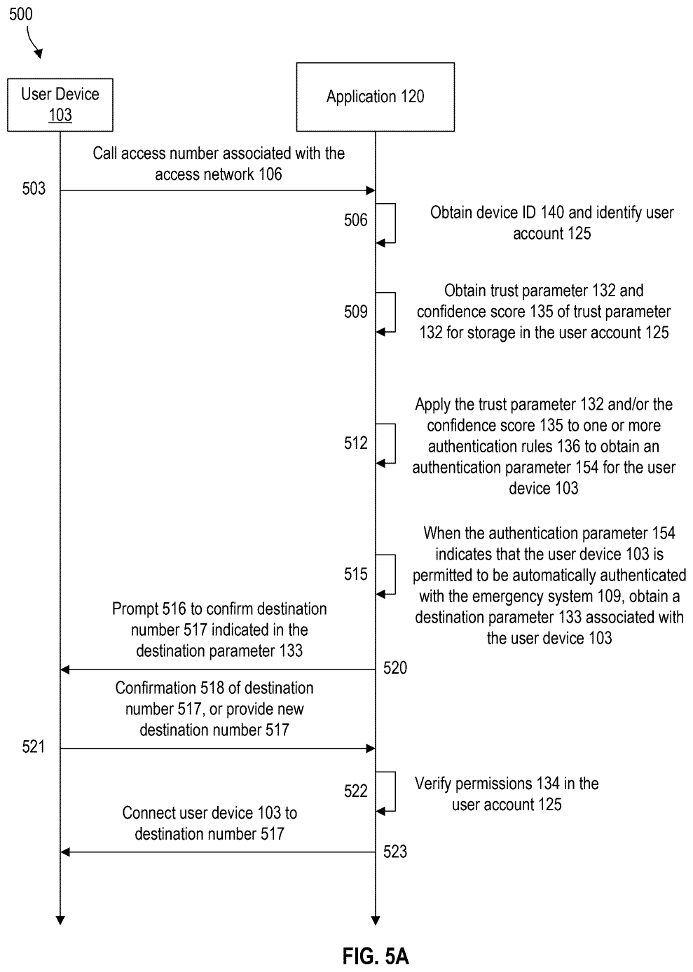

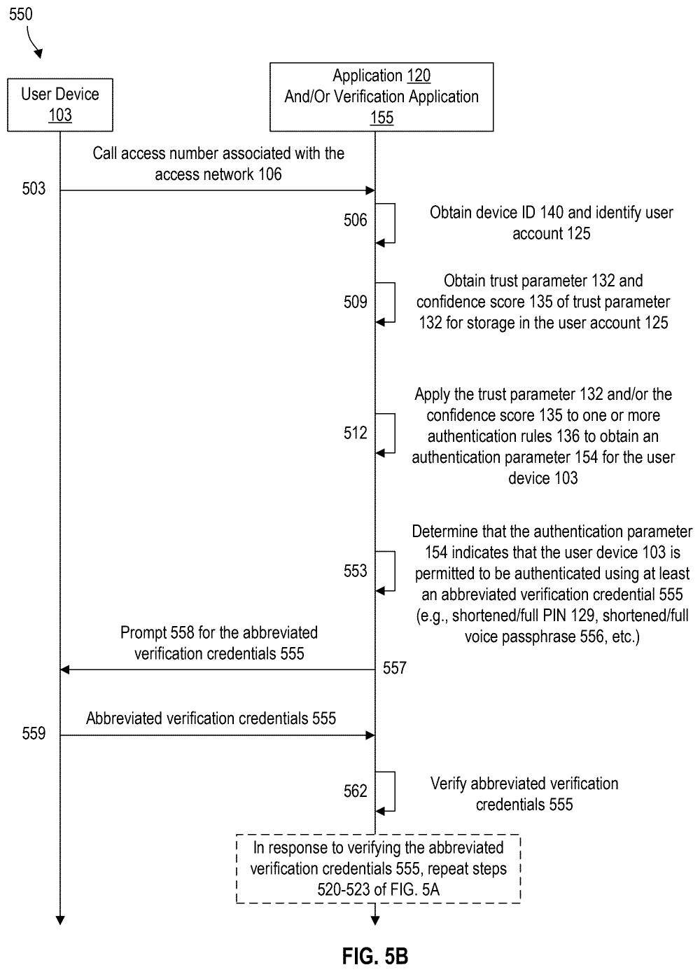

Referring now to FIGS. 5A and 5B, shown are message sequence diagrams illustrating methods performed by the user device 103, the application 120 at the emergency system 109, and the verification application 155 at the voice verification system 112. In particular, FIG. 5A illustrates a message sequence diagram for automatically authenticating a user device 103, and FIG. 5B illustrates a message sequence diagram for authenticating a user device 103 using abbreviated verification credentials.

Referring now specifically to FIG. 5A, shown is a message sequence diagram illustrating a method 500 for automatically authenticating a user device 103. At operation 503, a user operating the user device 103 may call an access number (e.g., phone number associated with the telecommunications service provider of the access network 106) to initiate a request to access emergency telecommunications services provided by the emergency system 109. At operation 506, the application 120 may obtain a device identifier 140 of the user device 103 that placed the calls, and then identify a user account 125 based on the device identifier 140 of the user device (if applicable). The application 120 may then obtain the applicable access history 137 from the user account 125 associated with the user device 103, and provide the applicable access history 137 to the AI model 114 as an input. The AI model 114 may output a predicted trust parameter 132 indicating a trust level of the user device 103 and a confidence score 135 of the trust parameter 132 and then provide the predicted trust parameter 132 and the confidence score 135 to the application 120. At operation 509, the application 120 may obtain (e.g., determine using the AI model 114 or receive from the AI model 114) the trust parameter 132 and the confidence score 135 for storage in the user account 125 at the data store 123.

At operation 512, the application 120 may apply the trust parameter 132 and/or the confidence score 135 to one or more authentication rules 136 to obtain (e.g., determine) an authentication parameter 154 identifying a permitted dynamic authentication for the user device 103. At operation 515, when the authentication parameter 154 indicates that the user device 103 is permitted to be automatically authenticated with the emergency system 109, the application 120 may then obtain (e.g., determine using the AI model 114 or receive from the AI model 114) a destination parameter 133 associated with the user device 103. For example, the destination data 152 from the access history 137 of the user account 125 may be provided as input into the AI model 114, and the AI model 114 may output a destination parameter 133 identifying a predicted destination number 517 or a destination address that user device 103 is likely to request a connection with using the services. The AI model 114 may also output a confidence score 135 of the predicted destination parameter 133.

At operation 520, the application 120 may transmit a prompt 516 to confirm a destination number 517 indicated in the predicted destination parameter 133. The prompt 516 may be transmitted as a voice recording, text, or other type of notification to the user device 103. At operation 521, the user device 103 may transmit a confirmation 518 of the destination number 517 received in the prompt 516 or provide a new destination number 517 to request a connection using the services. At operation 522, the application 120 may receive the confirmed destination number 517 and verify that the permissions 134 in the user account 125 indicate that the user device 103 is permitted to connect to the destination number 517. At operation 523, the application 120 may connect the user device 103 to the destination number 517 to complete the requested call.

Referring now specifically to FIG. 5B, shown is a message sequence diagram illustrating a method 550 for permitting a user device 103 to authenticate with the emergency system 109 using abbreviated verification credentials. Method 550 begins with the operations 503, 506, 509, and 512 from method 500 of FIG. 5A, in which a user device 103 calls the emergency system 109, a trust parameter 132 and confidence score 135 are obtained for the user device 103, and an authentication parameter 154 is determined based on the trust parameter 132 and confidence score 135.

At operation 553, the application 120 may determine that the authentication parameter 154 indicates that the user device 103 is permitted to authenticate with the emergency system 109 using at least an abbreviated verification credential 555. For example, the abbreviated verification credential 555 may be a subset of the digits (e.g., the last 4 digits) of the 12-digit PIN 129. As another example, the abbreviated verification credential 555 may also be a shortened voice passphrase 556, which in one case may correspond to a portion of the voiceprint 167 stored at the voice verification system in association with the user. For example, the voiceprint 167 stored in association with the user may be a vocal recording/data including a statement and an indication of the last 4 digits of the 12-digit PIN (e.g., “It's me 0 4 3 6”). The shortened voice passphrase 556 may be “It's me”, “me”, “0 4 3 6”, or another subset of the words/digits in the voiceprint 167. In other cases, the shortened voice passphrase 556 may be a different passphrase that is different from the voiceprint 167, but is still captured in the voice of the user if true.

At operation 557, the application 120 may transmit a prompt 558 for the abbreviated verification credentials 555. The prompt 558 may be transmitted as a voice recording, text, or other type of notification to the user device 103. The user may listen via a speaker or headset of the user device 103, for an indication (e.g., dial tone, beep, recording requesting user to enter abbreviated verification credentials 555, etc.) of the prompt 558 signaling the user to enter the abbreviated verification credentials 555 of the user. The user may provide the abbreviated verification credentials 555 to the user device 103, for example, by manually entering the abbreviated verification credentials 555 into a keypad of the user device 103, or speaking the shortened voice passphrase 556 into a microphone of the user device 103. The user device 103 may capture the abbreviated verification credentials 555 as text or as a recording of the shortened voice passphrase 556. At operation 559, the user device 103 may transmit the abbreviated verification credentials 555 to the emergency system 109.

At operation 562, the application 120 and/or the verification application 155 at the voice verification system 112 may verify the abbreviated verification credentials 555 received from the user device 103. For example, the abbreviated verification credential 555 may be a subset of the digits (e.g., the last 4 digits) of the 12-digit PIN 129. In this case, the application 120 may receive the subset of digits, and determine whether the subset of digits is included in the PIN 129 of the user account 125 associated with the user device 103 to authenticate the user device 103 with the emergency system 109. When the subset of digits is included in the PIN 129 of the user account 125, the application 120 may verify the abbreviated verification credentials 555 received from the user device 103.

As another example, the abbreviated verification credential 555 may be a shortened voice passphrase 556, which may or may not correspond directly to the voiceprint 167 stored at the data store 158 in association with the user. Regardless, the verification application 155 may verify the shortened voice passphrase 556 using the voice data 164 of the user stored at the voice verification system 112 identifying the distinct vocal features of the user and voice biometrics/verifications algorithms of the voice verification system 112. The verification application 155 may determine whether the shortened voice passphrase 556 matches (e.g., is consistent with) the voiceprint 167/voice data 164 of the user at least above a threshold confidence level, and then pass a voice verification key 131 back to the application 120 at the emergency system 109 indicating the verification of the shortened voice passphrase 556. The application 120 may validate that the voice verification key 131 is stored in the user account 125 associated with the user device 103 to authenticate the user device 103 with the emergency system 109.

In some cases, the verification application 155 may use the AI model 114 to determine whether the shortened voice passphrase 556 matches (e.g., is consistent with) the voiceprint 167/voice data 164 of the user stored at the data store 158. For example, the verification application 155 may use the AI model 114 to identify patterns and trends in the voice of the user using the voice data 164. The identified patterns and trends may be used to identify the vocal features of the user, which may be used to predict whether an incoming shortened voice passphrase 556 is consistent with the voice data 164 of the user and may be used to determine a confidence score 135 of the prediction. For example, the verification application 155 may determine that shortened voice passphrase 556 is consistent with the voice data 164 stored at the data store 158 when the confidence score 135 is greater than a preset threshold. Alternatively, the verification application 155 may determine that shortened voice passphrase 556 is not consistent with the voice data 164 stored at the data store 158 when the confidence score 135 is greater that a preset threshold.

As shown in FIG. 5B, after the abbreviated verification credentials 555 have been verified, method 550 may proceed to perform operations 520-523 of method 500 shown in FIG. 5A. In particular, the application 120 may transmit a prompt 516 (with or without a predicted destination number 517) to the user device 103, receive the requested destination number 517 for the user device 103, verify that the user device 103 is permitted to connect to the requested destination number 517, and then complete the call between the user device 103 and the requested destination number 517.

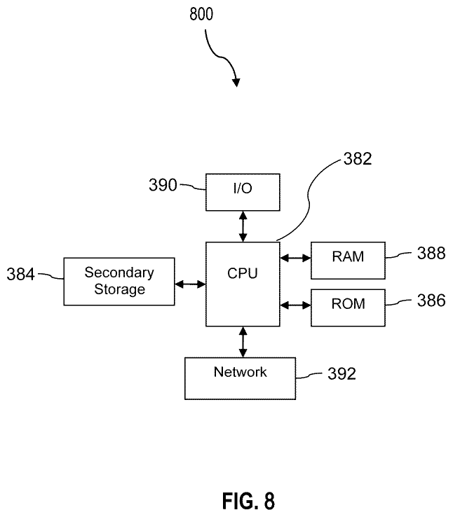

Referring now to FIG. 6, shown is a method 600 of providing emergency telecommunications services using AI-based authentication. Method 600 may be performed by the application 120 of the emergency system 109, in communication with the verification application 155 of the voice verification system 112. In embodiments, the method 600 may be implemented using a computer system with components as shown in FIG. 8. As illustrated, method 600 of FIG. 6 includes a number of enumerated operations, but embodiments of the operations in FIG. 6 may include additional operations before, after, and in between the enumerated operations. In some embodiments, one or more of the enumerated operations may be omitted or performed in a different order. In the embodiment of method 600, the emergency system 109 provides GETS.

At step 603, method 600 comprises maintaining, by an application 120 executed at an emergency telecommunications service system 109, an access history 137 of a user registered with the emergency telecommunications service system 109. The access history 137 includes one or more device identifiers 140 of user devices 103 operated by the user when previously accessing the emergency telecommunications service system 109 and a PIN 129 provided by the user devices 103 when previously requesting access to the emergency telecommunications service system 109. At step 605, method 600 comprises receiving, by the application 120, a call from a user device 103 operated by the user, in which the call indicates a device identifier 140 of the user device 103.

At step 607, method 600 comprises obtaining, by the application 120, using an AI model 114, a trust parameter 132 and a confidence score 135 based on the device identifier 140 of the user device 103 and the access history 137 of the user. The trust parameter 132 comprises a predicted value indicating a level of trust associated with the user device 103, and the confidence score 135 indicates a confidence level of the trust parameter 132. At step 609, method 600 comprises determining, by the application 120, an authentication parameter 154 indicating a permitted dynamic authentication for the user device 103 based on an authentication rule 136. The authentication rule 136 comprises one or more conditions 403A, 403B based on a comparison of at least one of the trust parameter 132 or confidence score 135 with a preset threshold 406A, 406B. At step 611, method 600 comprises transmitting, by the application 120, a destination prompt 516 to the user device 103 indicating a predicted destination number 517 to connect to using the emergency telecommunications service system 109 when the authentication parameter 154 indicates that the user device 103 is permitted to automatically authenticate with the emergency telecommunications service system 109.

Method 600 may include other steps and/or features that are not otherwise shown in FIG. 6. In an embodiment, the authentication parameter 154 indicates that the user device 103 is permitted to authenticate with the emergency telecommunications service system 109 using an abbreviated verification credential 555, and the method 600 may further comprise transmitting, by the application 120, an authentication prompt 558 to the user device 103 for the abbreviated verification credential 555, wherein the abbreviated verification credential 555 comprises at least one of a subset of the digits in the PIN 129 associated with the user or a shortened voice passphrase 556 capable of authentication at a voice verification system 112 of the communication network 100, receiving, by the application 120, the abbreviated verification credential 555 from the user device 103, and authenticating, by the application 120, the user device 103 using the abbreviated verification credential 555.

In an embodiment, the abbreviated verification credential 555 comprises the subset of the digits in the PIN 129 associated with the user, wherein authenticating the user device 103 using the abbreviated verification credential 555 comprises identifying, by the application 120, the PIN 129 associated with the user device 103 based on the access history 137 of the user stored in a user account 125 of the user, and determining, by application 120, that the subset of the digits in the PIN 129 received from the user device 103 is included in the PIN 129 associated with the user device 103 included in the user account 125 of the user. In an embodiment, the abbreviated verification credential 555 comprises the shortened voice passphrase 556, wherein authenticating the user device 103 using the abbreviated verification credential 555 comprises transmitting, by the application 120, the shortened voice passphrase 556 to the voice verification system 112 to determine that the shortened voice passphrase 556 is consistent with at least one of voice data 164 or a voiceprint 167 of the user stored at the voice verification system 112, receiving, by the application 120, a voice verification key 131 from the voice verification system 112, wherein the voice verification key 131 indicates that the shortened voice passphrase 556 is consistent with the at least one of the voice data 164 or the voiceprint 167 of the user stored at the voice verification system 112, and determining, by application 120, that a user account 125 of the user includes the voice verification key 131.

In an embodiment, method 600 may further comprise evaluating, by the application 120, location-based parameters 153 associated with the user device 103, wherein the location-based parameters 153 comprise at least one of a location of the user device 103, a cell tower to which the user device 103 is communicatively attached, or successful authentication of other devices within a threshold distance from the user device 103. In an embodiment, after evaluating the location-based parameters 153 associated with the user device 103, method 600 may further comprise determining, by the application 120, that the authentication parameter 154 indicates that the user device 103 is permitted to be automatically authenticated with the emergency telecommunications service system 109. In an embodiment, the user device 103 is permitted to be automatically authenticated with the emergency telecommunications service system 109 for a predefined period of time.

Referring now to FIG. 7, shown is a method 700 of providing emergency telecommunications services using AI-based authentication. Method 700 may be performed by the application of the emergency system 109, in communication with the verification application 155 of the voice verification system 112. In embodiments, the method 700 may be implemented using a computer system with components as shown in FIG. 8. As illustrated, method 700 of FIG. 7 includes a number of enumerated operations, but embodiments of the operations in FIG. 7 may include additional operations before, after, and in between the enumerated operations. In some embodiments, one or more of the enumerated operations may be omitted or performed in a different order. In the embodiment of method 700, the emergency system 109 provides GETS.

At step 703, method 700 comprises receiving, by an application 120 executed at an emergency telecommunications service system 109, a call from a user device 103 operated by an emergency personnel, wherein the call indicates a device identifier 140 of the user device 103. At step 705, method 700 comprises obtaining, by the application 120, using an AI model 114, a trust parameter 132 and a confidence score 135 based on the device identifier 140 of the user device 103 and the access history 137 of the user. The trust parameter 132 comprises a predicted value indicating a level of trust associated with the user device 103, and the confidence score 135 indicates a confidence level of the trust parameter 132. At step 707, method 700 comprises determining, by the application 120, an authentication parameter 154 indicating a permitted dynamic authentication for the user device 103 based on an authentication rule 136. The authentication rule 136 comprises one or more conditions 403A, 403B based on a comparison of at least one of the trust parameter 132 or confidence score 135 with a preset threshold 406A, 406B.

At step 709, when the authentication parameter 154 indicates that the user device 103 is permitted to authenticate with the emergency telecommunications service system 109 using an abbreviated verification credential 555, method 700 comprises transmitting, by the application 120, an authentication prompt 557 to the user device 103 to provide the abbreviated verification credential 555 to authenticate with the emergency telecommunications service system 109. At step 711, when the authentication parameter 154 indicates that the user device 103 is permitted to automatically authenticate with the emergency telecommunications service system 109, method 700 comprises transmitting, by the application 120, a destination prompt 516 to the user device 103 requesting the user device 103 to provide a destination number 517 to connect to using the emergency telecommunications service system 109.

Method 700 may include other steps and/or features that are not otherwise shown in FIG. 6. In an embodiment, method 700 may further comprise obtaining, by the application 120, using the AI model 114, a destination parameter 133 of the user device 103 based on the device identifier 140 of the user device 103 and the access history 137 of the user, wherein the destination parameter 133 comprises a predicted destination number 517 that the user device 103 has a history of requesting a connection with during emergencies, and wherein the destination prompt 516 indicates the predicted destination number 517. In an embodiment, the access history includes one or more device identifiers 140 of user devices 103 operated by the user when previously accessing the emergency telecommunications service system and a PIN provided by the user devices 103 when previously requesting to the emergency telecommunications service 109.

In an embodiment, the authentication parameter 154 indicates that the user device 103 is permitted to authenticate with the emergency telecommunications service system 109 using an abbreviated verification credential 555, wherein the abbreviated verification credential 555 comprises at least one of a subset of the digits in the PIN 129 associated with the user or a shortened voice passphrase 556 capable of authentication at a voice verification system 112 of the communication network 100, and wherein the method 700 may further comprise receiving, by the application 120, the abbreviated verification credentials 555 from the user device 103, and determining, by the application 120, whether the user device 103 is authenticated to use the emergency telecommunications services based on the abbreviated verification credentials 555. In an embodiment, the authentication parameter 154 comprises a first condition 403A that the trust parameter 132 is to be greater than or equal to a first preset threshold 406A and a second condition 403B that the confidence score 135 is to be greater than or equal to a second preset threshold 406B, and when the trust parameter 132 meets the first condition 403A and the confidence score 135 meets the second condition 403B, the authentication parameter 154 indicates that the user device is permitted to automatically authenticate with the emergency telecommunications service system 109. In an embodiment, the authentication parameter 154 comprises a first condition 403A that the trust parameter 132 is to be greater than a first preset threshold 406A and less than a second preset threshold 406A and a second condition 403B that the confidence score 135 is to be greater than a third preset threshold 406B and less than fourth preset threshold 406B, and when the trust parameter 132 meets the first condition 403A and the confidence score 135 meets the second condition 403B, the authentication parameter 154 indicates that the user device 103 is permitted to authenticate with the emergency telecommunications service system 109 using an abbreviated verification credential 555. In an embodiment, method 700 may further comprise evaluating, by the application 120, location-based parameters 153 associated with the user device 103, wherein the location-based parameters 153 comprise at least one of a location of the user device 103, a cell tower to which the user device 103 is communicatively attached, or successful authentication of other devices within a threshold distance from the user device 103.

FIG. 8 illustrates a computer system 800 suitable for implementing one or more embodiments disclosed herein. In an embodiment, the user devices 103, the emergency system 109, the AI model 114, and/or the voice verification system 112 may each be implemented as the computer system 800. The computer system 800 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 800, at least one of the CPU 382, the RAM 388, and the ROM 386 are changed, transforming the computer system 800 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 800 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 800 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 800 to provide the functionality of a number of servers that is not directly bound to the number of computers in the computer system 800. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 800, at least portions of the contents of the computer program product to the secondary storage 384, to the ROM 386, to the RAM 388, and/or to other non-volatile memory and volatile memory of the computer system 800. The processor 382 may process the executable instructions and/or data structures in part by directly accessing the computer program product, for example by reading from a CD-ROM disk inserted into a disk drive peripheral of the computer system 800. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 800.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 800 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method implemented in a communication network including an access network to provide emergency telecommunications services using artificial intelligence-based authentication, wherein the method comprises:
maintaining, by an application executed at an emergency telecommunications service system, an access history of a user registered with the emergency telecommunications service system, wherein the access history includes one or more device identifiers of user devices operated by the user when previously accessing the emergency telecommunications service system and a personal identification number provided by the user devices when previously requesting access to the emergency telecommunications service system;
receiving, by the application, a call from a user device operated by the user, wherein the call indicates a device identifier of the user device;
obtaining, by the application, using an artificial intelligence model, a trust parameter and a confidence score based on the device identifier of the user device and the access history of the user, wherein the trust parameter comprises a predicted value indicating a level of trust associated with the user device, and wherein the confidence score indicates a confidence level of the trust parameter;
determining, by the application, an authentication parameter indicating a permitted dynamic authentication for the user device based on an authentication rule, wherein the authentication rule comprises one or more conditions based on a comparison of at least one of the trust parameter or confidence score with a preset threshold; and
when the authentication parameter indicates that the user device is permitted to automatically authenticate with the emergency telecommunications service system, transmitting, by the application, a destination prompt to the user device indicating a predicted destination number to connect to using the emergency telecommunications service system.

2. The method of claim 1, wherein the authentication parameter indicates that the user device is permitted to authenticate with the emergency telecommunications service system using an abbreviated verification credential, and wherein the method further comprises:
transmitting, by the application, an authentication prompt to the user device for the abbreviated verification credential, wherein the abbreviated verification credential comprises at least one of a subset of digits in the personal identification number associated with the user or a shortened voice passphrase capable of authentication at a voice verification system of the communication network;
receiving, by the application, the abbreviated verification credential from the user device; and
authenticating, by the application, the user device using the abbreviated verification credential.

3. The method of claim 2, wherein the abbreviated verification credential comprises the subset of the digits in the personal identification number associated with the user, wherein authenticating the user device using the abbreviated verification credential comprises:
identifying, by the application, the personal identification number associated with the user device based on the access history of the user stored in a user account of the user; and
determining, by the application, that the subset of the digits in the personal identification number received from the user device is included in the personal identifier number associated with the user device included in the user account of the user.

4. The method of claim 2, wherein the abbreviated verification credential comprises the shortened voice passphrase, wherein authenticating the user device using the abbreviated verification credential comprises:
transmitting, by the application, the shortened voice passphrase to the voice verification system to determine that the shortened voice passphrase is consistent with at least one of voice data or a voiceprint of the user stored at the voice verification system;
receiving, by the application, a voice verification key from the voice verification system, wherein the voice verification key indicates that the shortened voice passphrase is consistent with the at least one of the voice data or the voiceprint of the user stored at the voice verification system; and
determining, by the application, that a user account of the user includes the voice verification key.

5. The method of claim 1, further comprising evaluating, by the application, location-based parameters associated with the user device, wherein the location-based parameters comprise at least one of a location of the user device, a cell tower to which the user device is communicatively attached, or successful authentication of other devices within a threshold distance from the user device.

6. The method of claim 5, wherein after evaluating the location-based parameters associated with the user device, the method further comprises determining, by the application, the authentication parameter indicating that the user device is permitted to be automatically authenticated with the emergency telecommunications service system.

7. The method of claim 1, wherein the user device is permitted to be automatically authenticated with the emergency telecommunications service system for a predefined period of time.

8. A method implemented in a communication network including an access network to provide emergency telecommunications services using artificial intelligence-based authentication, wherein the method comprises:
receiving, by an application executed at an emergency telecommunications service system, a call from a user device operated by a user, wherein the call indicates a device identifier of the user device;
obtaining, by the application, using an artificial intelligence model, a trust parameter and a confidence score based on the device identifier of the user device and an access history of the user, wherein the trust parameter comprises a predicted value indicating a level of trust associated with the user device, and wherein the confidence score indicates a confidence level of the trust parameter;
determining, by the application, an authentication parameter indicating a permitted dynamic authentication for the user device based on an authentication rule, wherein the authentication rule comprises one or more conditions based on a comparison of at least one of the trust parameter or confidence score with a preset threshold;
when the authentication parameter indicates that the user device is permitted to authenticate with the emergency telecommunications service system using an abbreviated verification credential, transmitting, by the application, an authentication prompt to the user device to provide the abbreviated verification credential to authenticate with the emergency telecommunications service system; and
when the authentication parameter indicates that the user device is permitted to automatically authenticate with the emergency telecommunications service system, transmitting, by the application, a destination prompt to the user device requesting the user device to provide a destination number to connect to using the emergency telecommunications service system.

9. The method of claim 8, further comprising obtaining, by the application, using the artificial intelligence model, a destination parameter of the user device based on the device identifier of the user device and the access history of the user, wherein the destination parameter comprises a predicted destination number that the user device has a history of requesting a connection with during emergencies, and wherein the destination prompt indicates the predicted destination number.

10. The method of claim 8, wherein the access history includes one or more device identifiers of user devices operated by the user when previously accessing the emergency telecommunications services and a personal identification number provided by the user devices when previously requesting access to the emergency telecommunications service.

11. The method of claim 8, wherein the authentication parameter indicates that the user device is permitted to authenticate with the emergency telecommunications service system using an abbreviated verification credential, wherein the abbreviated verification credential comprises at least one of a subset of digits in a personal identification number associated with the user or a shortened voice passphrase capable of authentication at a voice verification system of the communication network, and wherein the method further comprises:
receiving, by the application, the abbreviated verification credential from the user device; and
determining, by the application, whether the user device is authenticated to use the emergency telecommunications services based on the abbreviated verification credential.

12. The method of claim 8, wherein the authentication parameter comprises a first condition that the trust parameter is to be greater than or equal to a first preset threshold and a second condition that the confidence score is to be greater than or equal to a second preset threshold, and when the trust parameter meets the first condition and the confidence score meets the second condition, the authentication parameter indicates that the user device is permitted to automatically authenticate with the emergency telecommunications service system.

13. The method of claim 8, wherein the authentication parameter comprises a first condition that the trust parameter is to be greater than a first preset threshold and less than a second preset threshold and a second condition that the confidence score is to be greater than a third preset threshold and less than a fourth preset threshold, and when the trust parameter meets the first condition and the confidence score meets the second condition, the authentication parameter indicates that the user device is permitted to authenticate with the emergency telecommunications service system using an abbreviated verification credential.

14. The method of claim 8, further comprising evaluating, by the application, location-based parameters associated with the user device, wherein the location-based parameters comprise at least one of a location of the user device, a cell tower to which the user device is communicatively attached, or successful authentication of other devices within a threshold distance from the user device.

15. An emergency telecommunications service system, comprising:
a non-transitory memory;
a processor coupled to the non-transitory memory; and
an application stored at the non-transitory memory, which when executed by the processor, causes the processor to be configured to:
receive a call from a user device operated by a user, wherein the call indicates a device identifier of the user device;
obtain, using an artificial intelligence model, a trust parameter and a confidence score based on the device identifier of the user device and an access history of the user, wherein the trust parameter comprises a predicted value indicating a level of trust associated with the user device, and wherein the confidence score indicates a confidence level of the trust parameter;
determine an authentication parameter indicating a permitted dynamic authentication for the user device based on an authentication rule, wherein the authentication rule comprises one or more conditions based on a comparison of at least one of the trust parameter or confidence score with a preset threshold;
when the authentication parameter indicates that the user device is permitted to authenticate with the emergency telecommunications service system using an abbreviated verification credential, transmit an authentication prompt to the user device to provide the abbreviated verification credential to authenticate with the emergency telecommunications service system; and
when the authentication parameter indicates that the user device is permitted to automatically authenticate with the emergency telecommunications service system, transmit a destination prompt to the user device requesting the user device to provide a destination number to connect to using the emergency telecommunications services.

16. The emergency telecommunications service system of claim 15, wherein the application further causes the processor to be configured to obtain, using the artificial intelligence model, a destination parameter of the user device based on the device identifier of the user device and the access history of the user, wherein the destination parameter comprises a predicted destination number that the user device has a history of requesting a connection with during emergencies, and wherein the destination prompt indicates the predicted destination number.

17. The emergency telecommunications service system of claim 15, wherein the access history includes one or more device identifiers of user devices operated by the user when previously accessing the emergency telecommunications services and a personal identification number provided by the user devices when previously requesting access to the emergency telecommunications service system.

18. The emergency telecommunications service system of claim 15, when the authentication parameter indicates that the user device is permitted to authenticate with the emergency telecommunications service system using an abbreviated verification credential, wherein the abbreviated verification credential comprises at least one of a subset of digits in a personal identification number associated with the user or a shortened voice passphrase capable of authentication at a voice verification system coupled to the emergency telecommunications service system.

19. The emergency telecommunications service system of claim 15, wherein the authentication parameter comprises a first condition that the trust parameter is to be greater than or equal to a first preset threshold and a second condition that the confidence score is to be greater than or equal to a second preset threshold, and when the trust parameter meets the first condition and the confidence score meets the second condition, the authentication parameter indicates that the user device is permitted to automatically authenticate with the emergency telecommunications service system.

20. The emergency telecommunications service system of claim 15, wherein the authentication parameter comprises a first condition that the trust parameter is to be greater than a first preset threshold and less than a second preset threshold and a second condition that the confidence score is to be greater than a third preset threshold and less than a fourth preset threshold, and when the trust parameter meets the first condition and the confidence score meets the second condition, the authentication parameter indicates that the user device is permitted to authenticate with the emergency telecommunications service system using an abbreviated verification credential.
